(19) United States
(12) Patent Application Publication
(10) Pub. No.: US 2012/0240825 A1
(43) Pub. Date: Sep. 27, 2012

(54) Low-Shrinkage Binder System

(76) Inventors: Uwe Gehrig, St. Georgen (DE); Florian Ellenrieder, Augsburg (DE); Katja Voland, Berlin (DE); Mathias Degenkolb, Neustadt (DE); Joachim Riedmiller, Friedberg (DE)

(21) Appl. No.: 13/496,544

(22) PCT Filed: Aug. 2, 2010
(86) PCT No.: PCT/EP2010/061190

§ 371 Date: Jun. 1, 2012

(30) Foreign Application Priority Data
Sep. 22, 2009 (EP) 09170930.3

(51) Int. Cl. C04B 14/00; C08L 83/06; C08L 83/05; C08L 83/07; C09D 183/07; C04B 18/06; C08K 3/00; C04B 28/08; C09D 183/05; C09D 183/06; C04B 16/04; C08K 3/36

(52) U.S. Cl. 106/708; 106/823; 106/483; 524/588; 524/547; 524/447; 524/493; 106/487; 524/3; 106/790; 106/638; 106/471; 106/489

(57) ABSTRACT

The invention relates to mixtures containing alkali-activatable aluminosilicate binders, characterized in that the mixture contains organosiloxane compounds, to the use of organosiloxane compounds for reducing shrinkage in alkali-activatable aluminosilicate binders and to the use for hydrophobization of alkali-activatable aluminosilicate binders. The invention furthermore relates to joint mortars, levelling compounds or coatings which contain the mixtures according to the invention.

The present invention relates to mixtures containing alkali-activatable aluminosilicate binders, preferably solid binder mixtures, particularly preferably building material mixtures, which contain organosiloxane compounds for reducing shrinkage. Furthermore, the invention relates to the use of organosiloxane compounds as shrinkage reducers in alkali-activatable aluminosilicate binders. The invention also relates to joint mortars, levelling compounds or coatings which contain the mixtures according to the invention.

Alkali-activatable aluminosilicate binders are inorganic binder systems which are based on reactive water-insoluble oxides based on, inter alia, silicon dioxide in combination with aluminium oxide. They harden in an aqueous alkaline medium. Such binder systems are also generally known by the term geopolymers. Geopolymers are described, for example, in the documents EP 0 026 687, EP 0 153 097 B1 and WO 82/00816.

For example, ground granulated blast furnace slag, metakaolin, slag, fly ash, activated clay or a mixture thereof can be used as the reactive oxide mixture. The alkaline medium for activating the binder usually consists of aqueous solutions of alkali metal carbonates, sulphates, fluorides and in particular alkali metal hydroxide and/or soluble waterglass. The hardened binders have a high mechanical and chemical stability. In comparison with cement, they may be more economical and more stable and may have a more advantageous CO₂ emission balance.

EP 1 236 702 A1 describes, for example, a waterglass-containing building material mixture for the production of mortars resistant to chemicals and based on a latent hydraulic binder, waterglass and a metal salt as a control agent. Granulated blast furnace slag can also be used as the latent hydraulic constituent. Alkali metal salts are mentioned and used as the metal salt.

An overview of substances suitable as alkali-activatable aluminosilicate binders appears in the literature reference Alkali-Activated Cements and Concretes, Caijun Shi, Pavel V. Krivenko, Della Roy, (2006), 30-63 and 277-297.

Alkali-activatable aluminosilicate binders have the advantage that many products otherwise obtained as waste in power generation or steel production (binders such as ground granulated blast furnace slag, fly ash, slag . . . ) can be put to expedient use. They are therefore distinguished by an advantageous energy balance (CO₂ emission balance).

Owing to the relatively low proportion of phases typically involved in the hydraulic setting reaction of cements, such as, for example, calcium silicate hydrate (CSH), calcium aluminate hydrate (CAH) and calcium aluminate silicate hydrate (CASH), in the binder, very good resistance to attack by acids can be achieved with these binders. (Alkali-Activated Cements and Concretes, Caijun Shi, Pavel V. Krivenko, Della Roy, (2006), 185-191, in particular section 9.4 Acid attack).

A major disadvantage of the known building material mixtures based on alkali-activatable aluminosilicate binders is, however, the so-called shrinkage. In the alkali-activated hardening process, a volume contraction of the hardening binder undesirably occurs owing to the incipient condensation. This effect is substantially more pronounced in comparison with the shrinkage of cementitious binders where a hydration reaction and no condensation reaction takes place. Average values of the shrinkage after 28 days under standard conditions according to DIN 12808-4 are, for example in the case of aluminosilicate binders, in the range of up to 10 mm m⁻¹ at relative humidities up to 50% in comparison with 0 to 2 mm·m⁻¹ in the case of cement.

Similarly to cementitious binder systems, the shrinkage leads to a substantially poorer quality of the hardened building materials also in the case of the alkali-activatable aluminosilicate binders. In particular, cracks may occur on the surface of the building material. Another disadvantage is that, apart from an unaesthetic impression, the stability to environmental influences (Alkali-Activated Cements and Concretes, Caijun Shi, Pavel V. Krivenko, Della Roy, (2006), 176-199, in particular chapter 7, Durability of alkali-activated cements and concretes) is also reduced. In particular the resistance to the penetration of water, salts (in particular chlorides, but also sulphates) and chemicals, particularly of acids, deteriorates. Moreover, the stability to the freezing and thawing cycle is reduced. The lifetime of the building materials is accordingly shortened. The fact that the corrosion of the structural steel mostly used is very greatly promoted by the penetration of water, salts, chemicals (acids) is to be regarded as being particularly problematic.

The prior art discloses the problem of shrinkage both in the case of cementitious systems and in the case of alkali-activatable aluminosilicate binders. The literature is concerned with a shrinkage reduction of cementitious systems; alcohols (e.g. low molecular weight polymers of ethylene oxide and propylene oxide and glycols) are particularly frequently used, as described, for example, in the documents EP-A-1 914 211 and U.S. Pat. No. 5,603,760.

EP1 050 518 A1 describes specific silicate materials which have at least one amorphous binder matrix containing alkali metal oxide and silicon dioxide, the ratio of silicon dioxide to alkali metal oxide being greater than 25. The binder system disclosed is not alkali-activatable and aluminosilicate binders are not disclosed. Hydrophobizing, preferably silicone-containing admixtures for the hydrophobization of the binder materials are likewise described, but not for reducing the shrinkage.

The shrinkage behaviour and influences which increase or reduce the shrinkage of systems not based on cement are presented in Alkali-Activated Cements and Concretes, Caijun Shi, Pavel V. Krivenko, Della Roy, (2006), 131-134 and 165-169. Uusually, attempts are made to minimize the shrinkage to a tolerable degree depending on the application by a suitable choice and combination of the base raw materials, i.e. of the aluminosilicate binders (for example fly ash, slag, metakaolin), the activator generally likewise contributing to the shrinkage behaviour to a considerable degree. For example, with the use of waterglass as an activator, very pronounced autogenous shrinkage (chemical shrinkage) occurs, which, for example, can be significantly reduced by substitution of the waterglass with sodium hydroxide solution (Alkali-Activated Cements and Concretes, Caijun Shi, Pavel V. Krivenko, Della Roy, (2006), 165-167, in particular section 6.8.2 Effect of activator). Owing to the circumstances described above, the person skilled in the art is limited in the choice of the binders and the combinations thereof by the shrinkage factor. Binders and activator compositions which would actually have good final properties, such as, for example, good compressive strength, scratch resistance and/or resistance to the freezing and thawing cycle, cannot be used or are difficult to use in practice owing to the excessively great shrinkage in the case of some materials. It should also be considered that the other end product properties are also changed by the optimization of the binders and activators with regard to the shrinkage. In order to obtain the desired product properties (little shrinkage and abovementioned end product properties), it is therefore necessary to optimize a complex system of parameters dependent on one another.

In addition to the autogenous shrinkage, there is the so-called drying shrinkage (Alkali-Activated Cements and Concretes, Caijun Shi, Pavel V. Krivenko, Della Roy, (2006), 133-134, in particular section 5.5.2 Drying shrinkage). This can be influenced by changing the ambient conditions (curing conditions, such as, in particular, temperature and relative humidity). Thus, this proportion of the shrinkage is vanishingly small at 100% relative humidity and very large at very low relative humidities. In order to ensure a very high and constant product quality, the shrinkage should in particular depend as little as possible on the circumstances of the curing (curing conditions). In practice, strict compliance with the ideal curing conditions in most cases would not be possible and this would in the end lead to large quality variations. Because of this, an effective method for shrinkage reduction should lead to good success in the shrinkage reduction, as far as possible substantially independently of boundary conditions, such as temperature and relative humidity.

In Effect of shrinkage-reducing admixtures on the properties of alkali-activated slag mortars and pastes, Palacios, M. Puertas, F., Cement and Concrete Research (2007), 37(5), 691-702, the effect of shrinkage reducers based on polypropylene glycol in alkali-activatable binder systems is investigated. Similarly to the area of cementitious binder systems, the investigations concentrate, with regard to alkali-activatable aluminosilicate binders in the literature, an generally low molecular weight shrinkage reducers known from the area of cement (generally alcohols), which are capable of reducing the surface tension of the mixing water.

The use of organosiloxane compounds in alkali-activatable aluminosilicate binders and in particular as agents for shrinkage reduction is not known.

It was an object of the present invention to provide building material mixtures which substantially avoid the abovementioned disadvantages of the prior art and in particular minimize the shrinkage. This is to be permitted with a good price/performance ratio, good environmental compatibility (waste balance and CO₂ emission balance) and good stability to environmental influences, in particular good acid stability of the building material mixtures. Moreover, the effectiveness with regard to the shrinkage reduction is to be improved, i.e. it is intended to achieve as far as possible a greater shrinkage reduction than that known in the prior art.

This object could be achieved by the mixtures according to the invention which contain alkali-activatable aluminosilicate binders, preferably solid binders, particularly preferably latent hydraulic binders (such as ground granulated blast furnace slag), and/or pozzolanas (for example natural pozzolanas comprising ashes and rocks of volcanic origin and/or synthetic pozzolanas, such as fly ashes, silica dust (microsilica), calcined ground clay and/or oil shale ash), particularly preferably ground granulated blast furnace slag, fly ash, microsilica, slag, activated clay and/or metakaolin mixtures and organosiloxane compounds, preferably hydrophobic organosiloxane compounds.

This object is also achieved by the use of the mixtures according to the invention for reducing the shrinkage in and/or for the hydrophobization of alkali-activatable aluminosilicate binders. Hydrophobization of the building materials has in particular the result that the penetration of water can be prevented by the water-repellent effect and hence a further improvement of the stability to environmental influences is achieved. Advantageously, the object is also achieved in joint mortars, levelling compounds or coatings which contain the mixtures according to the invention.

The mixtures according to the invention, also referred to below as building material mixture, have the advantage that low-shrinkage and high-quality mortars and concretes, in particular joint mortars, levelling compounds and coatings for the building industry, can be realized with them. Surprisingly, it was found that organosiloxane compounds have shrinkage-reducing properties.

Binders which may be used in the mixtures according to the invention are, for example, ground granulated blast furnace slag, kaolin, metakaolin, slag, fly ash, microsilica, activated clay, silicon oxides, trass, pozzolanas, kieselguhr, diatomaceous earth, gaize, aluminium oxides and/or mixed aluminium/silicon oxides. These substances are also known by the general terms latent hydraulic binders and pozzolanas. One or more of said binders may be used. Ground granulated blast furnace slag is most preferred.

Usually, the composition of mineral binders is stated as the respective oxide. However, this does not mean that the respective elements are also present or have to be present in the form of the oxides. Specification as oxide is merely a standardized form of presentation of the analytical results, as is usual in this technical area. The oxide composition of the preferably pulverulent, alkali-activatable binders and binder mixtures varies within relatively wide ranges depending on the type of binder. In a list which is not definitive, SiO₂ (preferably in an amount of 20 to 95% by weight, particularly preferably 30 to 75% by weight), Al₂O₃ (preferably 2-70% by weight, particularly preferably 5 to 50% by weight), CaO (preferably 0-60% by weight, particularly preferably 0 to 45% by weight, especially preferably 2 to 35% by weight) and M₂O (M=alkali metal, 0 to 40% by weight, particularly preferably 0.5 to 30% by weight) may be mentioned as the most important oxides.

In contrast to cements, aluminosilicate binders have for the most part amorphous and low-calcium phases. Owing to the high crystalline fraction of calcium silicate, calcium aluminate and calcium silicate aluminates, the cementitious clinker phases become hydrated on addition of water to calcium silicate hydrates, calcium aluminate hydrates and calcium silicate aluminate hydrates. However, these are only moderately stable to acids. Owing to the high amorphous fraction or owing to the lower content of calcium in alkali-activatable aluminosilicate binders (Portland cement: generally greater than 50% by weight CaO), phases which differ substantially from the cementitious phases accordingly form. Consequently, the content of Ca (usually stated as CaO) in the aluminosilicate binder should be in the quantity range mentioned in the preceding paragraph, in order to ensure good acid resistance.

Organosiloxane compounds are used as shrinkage reducers. Organosiloxane compounds are characterized by the presence of at least one Si—O—Si structural unit and by the presence of at least one hydrocarbon group which is bonded directly to silicon.

The various types of organosiloxanes and exemplary compounds are mentioned in detail in the preferred embodiments. The organosiloxane compounds are preferably present in an amount of 0.01 to 15% by weight, preferably 0.02 to 10% by weight and particularly preferably 0.05 to 8% by weight in the mixtures.

In a particularly preferred embodiment of the invention, the mixture contains ground granulated blast furnace slag, fly ashes and/or microsilica as binders. The better acid resistance of the binder (mixtures) owing in particular to their preferably high proportion of aluminate and silicate is advantageous here. Said binders are to a high degree amorphous and have relatively high and reactive surfaces. Consequently, the setting behaviour is accelerated. The proportion of aluminate (as Al₂O₃) and silicate (as SiO₂) should in total account for preferably more than 50% by weight, particularly preferably more than 60% by weight, based on the total mass of the binder (mixture). Ground granulated blast furnace slag as a particularly preferred alkali-activatable aluminosilicate binder can preferably be used in an amount between 5 and 90% by weight, preferably between 5 and 70% by weight, based in each case on the total weight of the mixture. The ground granulated blast furnace slag can be used, preferably in the abovementioned amount, alone or preferably together with pozzolanas, particularly preferably with microsilica and/or fly ash.

In a further preferred embodiment, metakaolin is present as the binder. The metakaolin can preferably be present in a proportion by weight of 1 to 60% by weight, particularly preferably 5 to 60% by weight, based in each case on the total weight of the mixture. Metakaolin can be used as a binder alone or in combination with one or more alkali-activatable aluminosilicate binders, preferably selected from the group consisting of ground granulated blast furnace slag, fly ashes and/or microsilica. Metakaolin is a thermally treated kaolin and, owing to its high amorphous fractions, is particularly reactive. It also sets rapidly, particularly when highly ground.

In a further preferred embodiment of the invention, the binders used are characterized in that they have a specific surface area (Blaine value) of greater than 2000 cm²/g, particularly preferably of 4000 to 4500 cm²/g. A high Blaine values will in general lead to high strengths and/or high setting reactivity.

Preferred are mixtures which contain at least one organosiloxane compound of the structural formula (I)

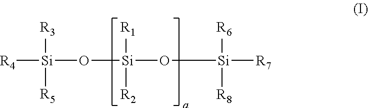

in which a is an integer from 1 to 2000, preferably 1 to 500, particularly preferably 1 to 200,
R₁ and R₂ are identical or different and, independently of one another, are a branched or straight-chain alkyl having up to 20 carbon atoms,
phenyl, vinyl,
—OH,
—H,
—CH₂—CHCH₃-phenyl,
—CH₂—CH₂—(CF₂)ₓ—CF₃, in which x is an integer from 0 to 20,
and/or —CH₂—CH₂—CH₂—(OA)ₙ-OR₉, in which A are identical or different and, independently of one another, are a branched or straight-chain alkylene having two to 10 carbon atoms, n are identical or different and, independently of one another, are an integer between 1 and 300 and R₉ are identical or different and, independently of one another, are a group selected from methyl, ethyl, phenyl and/or H,
R₃, R₄, R₅, R₆, R₇, R₈ are identical or different and, independently of one another, are a branched or straight-chain alkyl having up to 20 carbon atoms, phenyl, vinyl,
halogen,
—OR₁₀, where R₁₀ is selected from methyl, ethyl, phenyl and/or H,
—H,
and/or —CH₂—CH₂—CH₂—(OA)ₙ-OR₉, in which A are identical or different, and, independently of one another, are a branched or straight-chain alkylene having two to 10 carbon atoms, n are identical or different and, independently of one another, are an integer between 1 and 300 and R₉ are identical or different and, independently of one another, are a group selected from methyl, ethyl, phenyl and/or H. A is preferably propylene and/or ethylene, it being possible for these to be present as a block or in random distribution in the case of mixed alkylene oxide units. R9 is preferably a methyl group.

Polydimethylsiloxanes (repeating unit —Si(Me)₂O—, which may preferably be terminated with trimethylsilyloxy groups may be mentioned by way of example. CAS [9016-00-6] or CAS [63142-62-9]. Furthermore, copolymers having methyl and phenyl groups, such as diphenylsiloxane-dimethylsiloxane (CAS [68083-14-7]), phenylmethylsiloxane-dimethylsiloxane (CAS [63148-52-7]) and phenylmethylsiloxane-diphenylsiloxanes or homopolymers, such as, for example, phenylmethylsiloxanes (CAS [9005-12-3]).

Further examples are polydiethylsiloxanes (CAS (63148-61-8]), which may preferably be terminated with triethylsilyloxy groups.

It is also possible to use hydrosiloxanes, for example copolymers of methylhydrosiloxane-dimethylsiloxane (CAS [68037-59-2] and/or polymethylhydrosiloxane [63148-57-2]), which in each case are preferably terminated with trimethylsilyloxy groups. Hydrosiloxanes in which the ratio of the number of H atoms which are directly bonded to a silicon atom to the number of silicon atoms in the organosiloxane is less than 1:2, preferably less than 1:3, are particularly advantageous because excessively high proportions of hydride groups may adversely influence the shrinkage-reducing effect of the organosiloxanes.

It is also possible to use polysiloxanes which contain, in their structure, vinyl groups bonded to the silicon; these are preferably vinyl-terminated polysiloxanes. Vinyl-terminated dimethylsiloxanes (CAS [68083-19-2]), vinyl-terminated copolymers of diphenylsiloxane-dimethylsiloxane (CAS [68951-96-2]), vinyl-terminated polyphenylmethylsiloxanes (CAS [225927-21-9]) and vinyl-terminated diethylsiloxane-dimethylsiloxane copolymers may be mentioned by way of example. Copolymers of vinylmethylsiloxane-dimethylsiloxane which are terminated with trimethylsilyloxy groups may be mentioned as an example a siloxane containing vinyl groups which does not contain the vinyl groups as terminal groups.

For example, poly(3,3,3-trifluoropropylmethylsiloxane) may be used as a corresponding fluoro-containing siloxane compound. An advantage of the fluoro-modified siloxanes is the shrinkage-reducing effect in combination with increased hydrophobicity.

It is also possible to use dimethylsiloxanes, some of whose methyl groups were replaced by polyalkylene oxide units of the type —CH₂—CH₂—CH₂—(OA)ₙ-OR₉. Here, A is preferably an ethylene or propylene group or a mixture of alkylene and propylene in block form or random distribution. Polydimethylsiloxanes which are terminated with in each case a terminal group of the formula —Si(Me)₂-(CH₂)₃(OCH₂CH₂)ₘ—OH containing a hydroxypolyethylene glycol group may be mentioned by way of example.

An advantage of these siloxane compounds modified by alkylene oxide side chains is that the hydrophilic or hydrophobic properties can be very readily adjusted by modification of the chain length (repeating unit n) and especially of the ratio of ethylene oxide to propylene oxide. As a result, sufficient solubility of the organosiloxanes can preferably be established.

In a particularly preferred embodiment of the invention, the substituents R₁ and R₂ are identical or different and, independently of one another, are

methyl,

phenyl,

H,

and/or —CH₂—CH₂—CH₂—(OA)ₙ-OR₉, in which A are identical or different and, independently of one another, are a branched or straight-chain alkylene having two or three carbon atoms, n are identical or different and, independently of one another, are an integer between 1 and 300 and R₉ are identical or different and, independently of one another, are a group selected from methyl and/or H,

R₃, R₄, R₅, R₆, R₇, R₈ are identical or different and, independently of one another, are alkyl having up to 20 carbon atoms,

—OR₁₀, where R₁₀ is selected from methyl, ethyl, phenyl and/or H,

—H,

and/or —CH₂—CH₂—CH₂—(OA)ₙ-OR₉, in which A are identical or different and, independently of one another, are a branched or straight-chain alkylene having two or three carbon atoms, n are identical or different and, independently of one another, are an integer between 1 and 300 and R₉ are identical or different and, independently of one another, are a group selected from methyl and/or H.

Triethylsilyloxy-terminated polydiethylsiloxanes (CAS[63148-61-8]) or silanol-terminated polydimethylsiloxanes (CAS[70131-67-8]) may be mentioned by way of example. The advantage is that the shrinkage-reducing effect of the organosiloxane compounds can be optimized for different binder variations by a suitable choice of the terminal and side groups.

In a further particularly preferred embodiment of the invention, an organosiloxane compound of the structural formula (II) is present

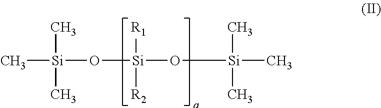

in which R₁ and R₂ are identical or different and, independently of one another, are

phenyl

methyl,

and/or —CH₂—CH₂—CH₂—(OA)ₙ-OR₉, in which A are identical or different and,

independently of one another, are a branched or straight-chain alkylene having two or three carbon atoms, n are identical or different and, independently of one another, are an integer between 1 and 300, and R₉ are identical or different and, independently of one another, are a group selected from methyl and/or H.

Phenylmethylsiloxane-dimethylsiloxane copolymers (CAS[63148-52-7]) or hydroxyalkyl-functionalized methylsiloxane-dimethylsiloxane copolymers (CAS[68937-54-2] or CAS[68957-00-6]) may be mentioned by way of example. The stable, unreactive terminal and side groups, which are not eliminated or do not react even at high pH, are advantageous.

A preferred embodiment of the invention comprises mixtures which contain, in the mixture, at least one cyclic organosiloxane compound of the structural formula (III)

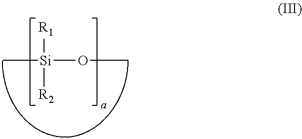

in which a is an integer from 3 to 6,

R₁ and R₂ are identical or different and, independently of one another, are

methyl,

phenyl,

vinyl,

—H,

and/or —CH₂—CH₂—CF₃.

Exemplary compounds for this are decamethylcyclopentasiloxane (CAS[541-02-6]), hexaphenylcyclotrisiloxane (CAS[512-63-0]) or pentamethylcyclopentasiloxane (CAS[6166-86-5]). The low viscosity and the associated easy processing or metering are advantageous here.

Embodiments of the invention in which cement is present in the mixtures, preferably in an amount of 0 to 50% by weight, preferably 0 to 25% by weight, particularly preferably 0 to 15% by weight and most preferably 0 to 10% by weight, are particularly advantageous. High-alumina cement with its relatively high proportion of aluminate is preferred to Portland cement (OPC).

The alkaline cement acts as an activator on mixing with water, so that the setting or hardening begins. A 1-component system (1C system=mixture of binder and an activator, such as, for example, cement) which can be activated for setting and hardening only by addition of water can therefore be provided in a particularly advantageous manner. Moreover, the presence of cement is advantageous if, in addition to the stability to acids, the stability to alkalis is also to be improved. The calcium silicate hydrate (CSH) and calcium aluminate silicate hydrate (CASH) phases in the cement have in fact the property of being relatively stable to alkalis. By suitable choice of the binders, it is therefore possible to control the properties of the hardened building materials.

Mixtures according to the invention which contain no cement are preferred. In particular, these are suitable for the preparation of particularly acid-resistant building material mixtures.

In a preferred embodiment of the invention, an activator is present; this is particularly preferably pulverulent.

The activator may also be used in the form of a solution. In this case, the activator solution is usually mixed with an alkali-activatable binder or a binder mixture, whereupon the hardening begins.

The mixtures preferably contain, as an activator, at least one alkali metal compound, e.g. alkali metal silicates, alkali metal sulphates, carbonates of alkali or alkaline earth metals, such as, for example, magnesium carbonate, calcium carbonate, potassium carbonate, sodium carbonate, lithium carbonate, cement, alkali metal salts of organic and inorganic acids; sodium, potassium and lithium hydroxide and/or calcium and magnesium hydroxide are particularly preferred.

In principle, any compound which is alkaline in aqueous systems can be used.

In a preferred embodiment of the invention, alkali metal and/or alkaline earth metal hydroxides are used as the activator. The alkali metal hydroxides are preferred owing to their high alkalinity.

The use of waterglass, preferably liquid waterglass, in particular alkaline potassium or sodium waterglass, is furthermore preferred. This may be Na, K or lithium waterglass, potassium waterglass being particularly preferred. The modulus (molar ratio of SiO₂ to alkali metal oxide) of the waterglass is preferably less than 4, preferably less than 2. In the case of waterglass powder, the modulus is less than 5, preferably between 1 and 4, particularly preferably between 1 and 3.

In a further preferred embodiment, the mixtures contain at least one alkali metal aluminate, carbonate and/or sulphate as activators.

The activator may be used in aqueous solution. The concentration of the activator in the solution may be based on generally customary practice. The alkaline activation solution preferably comprises sodium, potassium or lithium hydroxide solutions and/or sodium, potassium or lithium silicate solutions having a concentration of 0.1 to 60% by weight of solid, preferably 1 to 55% by weight of solid. The amount used in the binder system is preferably 5 to 80% by weight, particularly preferably 10 to 70% by weight, especially preferably 20 to 60% by weight.

Especially preferable are mixtures which contain:

The organosiloxane compounds are preferably present in the mixtures in an amount of 0.01 to 15% by weight, preferably 0.02 to 10% by weight and particularly preferably 0.05 to 8% by weight.

Particularly preferred mixtures are those which contain the organosiloxane compounds in the before standing weight ratios,

between 5 and 90% by weight,

preferably between 5 and 70% by weight,

particularly preferably between 10 and 60% by weight, of ground granulated blast furnace slag,

between 0 and 70% by weight,

preferably between 5 and 70, particularly preferably between 5 and 50% by weight, of microsilica and/or fly ashes. In addition, the mixture may preferably contain aqueous activator solutions, or particularly preferably pulverulent activators in an amount between 0.1 and 90% by weight, preferably between 1 and 80% by weight, particularly preferably between 2 and 70% by weight.

The stated weights are based in each case on the total weight of the mixture.

The organosiloxanes according to the invention can preferably be mixed with the alkali-activatable, preferably pulverulent aluminosilicate binders. Preferably, these are applied as a coating to the binder or binders and/or filler or fillers.

It is also possible in addition to mix preferably pulverulent activator according to one of the preferred embodiments of the invention with the binder or to coat the binder and/or optionally the fillers therewith. This gives a 1-component system which can be activated to harden only by the addition of water.

2-Component systems (2-C systems) are characterized in that an activator, preferably an aqueous activator solution, is added to the binder. Once again, the generally alkaline activator systems according to the preferred embodiments of the invention are suitable as the activator. It is preferably also possible to use the organosiloxanes according to the invention, suitable as shrinkage reducers, in the aqueous activator solution. It is advantageous to produce stable emulsions by addition of suitable surfactants, such as, for example, sodium dodecylsulphate, in order to prevent a phase separation of the organosiloxanes in the aqueous environment.

In a particularly preferred embodiment of the invention, the following components are present in the mixture:

between 0.01 and 15% by weight, preferably 0.02 to 10% by weight and particularly preferably 0.05 to 8% by weight of organosiloxane, preferably selected from the group consisting of alpha,omega-trimethylsilylpolydimethylsiloxane and/or hydroxyalkyl-functionalized polydimethylsiloxanes, between 1 and 90% by weight of alkali-activatable aluminosilicate binder, preferably 5 to 80% by weight, particularly preferably 10 to 70% by weight, preferably solid binders, particularly preferably latent hydraulic binders (such as ground granulated blast furnace slag), and/or pozzolanas (for example natural pozzolanas comprising ashes and rocks of volcanic origin and/or synthetic pozzolanas, such as fly ashes, silica dust (microsilica), calcined ground clay and/or oil shale ash), particularly preferably ground granulated blast furnace slag, fly ash, microsilica, slag, activated clay and/or metakaolin, and

between 0.1 and 90% by weight of activator, preferably 1 to 80% by weight, particularly preferably 2 to 70% by weight. The stated weights are based in each case on the total weight of the mixture.

Optionally, between 0 and 80% by weight, particularly preferably between 30 and 70% by weight, of fillers and optionally between 0 and 15% by weight of additives, preferably additives differing from the abovementioned components, may be present in the mixtures.

The stated weights are based in each case on the total weight of the mixtures.

The binder system according to the invention is preferably used for the production of mortars and concretes. For the production of such mortars and concretes, the binder system described above is usually mixed with further components, such as fillers, latent hydraulic substances and further additives. The addition of pulverulent activator is preferably effected before said components are mixed with water, so that a so-called premix dry mortar is produced. Thus, the activation component is present in pulverulent form, preferably as a mixture with the binders and/or sand. Alternatively, an aqueous, preferably alkaline activation solution can be added to the other pulverulent components. In this case, a two-component binder is then referred to.

Generally known gravels, sands and/or flours are suitable as a filler, for example those based on quartz, limestone, barite or clays. Light fillers, such as Perlite, kieselguhr (diatomaceous earth), expanded mica (vermiculite) and foamed sand, may be used. The proportion of the fillers in the mortar or concrete can usually be between 0 and 80% by weight, based on the total weight of the mortar or concrete, depending on application.

Suitable additives are generally known plasticizers, antifoams, water retention agents, pigments, fibres, dispersion powders, wetting agents, retardants, accelerators, complexing agents, aqueous dispersions and rheology modifiers.

The invention also relates to the use of organosiloxanes, preferably selected from the group consisting of the polydimethylsiloxanes, for reducing the shrinkage in alkali-activatable aluminosilicate binders, preferably solid binders, particularly preferably latent hydraulic binders (such as ground granulated blast furnace slag), and/or pozzolanas (for example natural pozzolanas comprising ashes and rocks of volcanic origin and/or synthetic pozzolanas, such as fly ashes, silica dust (microsilica), calcined ground clay and/or oil shale ash), particularly preferably ground granulated blast furnace slag, fly ash, microsilica, slag, activated clay and/or metakaolin.

The invention also relates to the use of organosiloxanes, preferably selected from the group consisting of the fluoro-containing siloxane compounds, for the hydrophobization of alkali-activatable aluminosilicate binders, preferably solid binders, particularly preferably latent hydraulic binders (such as ground granulated blast furnace slag), and/or pozzolanas (for example natural pozzolanas comprising ashes and rocks of volcanic origin or synthetic pozzolanas, such as fly ashes, silica dust (microsilica), calcined ground clay and/or oil shale ash), particularly preferably of ground granulated blast furnace slag, fly ash, microsilica, slag, activated clay and/or metakaolin.

The organosiloxanes are suitable in each case for the uses for reducing shrinkage and hydrophobization for all aluminosilicate binders described in this invention.

The present invention furthermore relates to joint mortars, levelling compounds or coatings which contain the mixtures according to the invention.

### EXAMPLES

1. Shrinkage Reduction

Sample Preparation:

The preparation of the mixtures is expediently effected by first premixing all pulverulent binder constituents according to Tables 1, 3, 5 and 7. Thus, in the first step, for example, the binders ground granulated blast furnace slag, microsilica and/or metakaolin are premixed together with the quartz sand filler.

For the preparation of the mixtures according to the invention (M1a, M2a and M3a), this mixture is sprayed in the second step with the respective siloxane and mixed again.

The preparation of a homogeneous mixture by addition of the activator with stirring is then effected according to DIN EN 196.

Production and storage of the test specimens, or tests:

Test specimen prisms having the dimensions 4×4×16 cm³ are produced from the stirred binders according to DIN EN 196 and stored according to said standard at a temperature of 23° C. and relative humidity of 50%. The shrinkage measurement is then effected, likewise according to the abovementioned standard.

All mixtures mentioned are two-component mixtures since the activators (potassium waterglass or sodium hydroxide solution) are added separately. The mixtures M1, M1a, M2, M3, M4 and M5 are mentioned as comparative systems and, in comparison with the Examples M1b, M1c, M1d, M1e, M1f, M1g, M1h, M1i, M2a, M3a, M4a and M5a according to the invention, contain no additive according to the invention.

### Example 1

TABLE 1
Test formulations, data in parts by mass

| Raw materials | M1 | M1a | M1b | M1c | M1d |
|---|---|---|---|---|---|
| Ground granulated blast furnace slag | 200 | 200 | 200 | 200 | 200 |
| Microsilica | 50 | 50 | 50 | 50 | 50 |
| Metakaolin | | | | | |
| Quartz sand | 750 | 750 | 750 | 750 | 750 |
| Polyethylene glycol (Pluriol P600 ®, | | 10 | | | |
| from BASF) | | | | | |
| Polydimethylsiloxane (AK 1000 ®, | | | 10 | | |
| from Wacker) | | | | | |
| Polydimethylcyclosiloxane (Z 040 ®, | | | | 10 | |
| from Wacker) | | | | | |
| Polydimethylsiloxane having phenyl | | | | | 10 |
| groups (Advalon PN 1000 ®, from | | | | | |
| Wacker) | | | | | |
| Potassium waterglass | 250 | 250 | 250 | 250 | 250 |
| (modulus 1, solids content 40%) | | | | | |

TABLE 2
Results of the shrinkage measurement in mm · m⁻¹

| Age/days | M1 | M1a | M1b | M1c | M1d |
|---|---|---|---|---|---|
| 1 | 0.00 | 0.00 | 0.00 | 0.00 | 0.00 |
| 2 | −1.28 | −1.29 | −1.55 | −1.66 | −1.26 |
| 5 | −2.99 | −2.71 | −2.69 | −2.94 | −2.45 |
| 7 | −3.48 | −3.13 | −2.92 | −3.20 | −2.78 |
| 14 | −4.19 | −3.81 | −3.31 | −3.56 | −3.35 |
| 21 | −4.56 | −4.04 | −3.51 | −3.76 | −3.66 |
| 28 | −4.75 | −4.21 | −3.68 | −3.95 | −3.89 |
| Shrinkage reduction after 28 d | | 11% | 22% | 17% | 18% |

On comparison of the shrinkage values after 28 days, substantial reductions in shrinkage are evident both on addition of polydimethylsiloxane (M1b) and in the case of polydimethylcyclosiloxane (M1c) and polydimethylsiloxane having phenyl groups (M1d). In comparison with the known polyethylene glycols as shrinkage reducers (M1a), polysiloxanes show substantially better shrinkage values at the same dose.

### Example 2

TABLE 3
Test formulations, data in parts by mass

| Raw materials | M1 | M1e | M1f | M1g |
|---|---|---|---|---|
| Ground granulated blast furnace slag | 200 | 200 | 200 | 200 |
| Microsilica | 50 | 50 | 50 | 50 |
| Metakaolin | | | | |
| Quartz sand | 750 | 750 | 750 | 750 |
| Polyether-modified polydimethylsiloxane | | 10 | | |
| (Silbyk 9200 ®, from Byk) | | | | |
| OH-terminated polydimethylsiloxane | | | 10 | |
| (Polymer FD 6 ®, from Wacker) | | | | |
| Fluorine-modified polydimethylsiloxane | | | | 10 |
| (AF 98/100 ®, from Wacker) | | | | |
| Potassium waterglass | 250 | 250 | 250 | 250 |
| (modulus 1, solids content 40%) | | | | |

TABLE 4
Results of the shrinkage measurement in mm · m⁻¹

| Age/days | M1 | M1e | M1f | M1g |
|---|---|---|---|---|
| 1 | 0.00 | 0.00 | 0.00 | 0.00 |
| 2 | −1.28 | −0.49 | −1.41 | −1.16 |
| 5 | −2.99 | −2.09 | −2.50 | −2.23 |
| 7 | −3.48 | −2.41 | −2.71 | −2.49 |
| 14 | −4.19 | −2.98 | −3.12 | −2.97 |
| 21 | −4.56 | −3.22 | −3.30 | −3.25 |
| 28 | −4.75 | −3.38 | −3.49 | −3.46 |
| Shrinkage reduction after 28 d | | 29% | 27% | 27% |

Further siloxane additives, such as a polyether-modified polydimethylsiloxane (M1e), an OH-terminated polydimethylsiloxane (M1f) or a fluorine-modified polydimethylsiloxane (M1g), likewise have good shrinkage-reducing properties.

### Example 3

TABLE 5
Test formulations, data in parts by mass

| Raw materials | M1 | M1h | M1i |
|---|---|---|---|
| Ground granulated blast furnace slag | 200 | 200 | 200 |
| Microsilica | 50 | 50 | 50 |
| Metakaolin | | | |
| Quartz sand | 750 | 750 | 750 |
| Polydimethylsiloxane (AK 100 ®, from Wacker) | | 10 | 20 |
| Potassium waterglass | 250 | 250 | 250 |
| (modulus 1, solids content 40%) | | | |

TABLE 6
Results of the shrinkage measurement in mm · m⁻¹

| Age/days | M1 | M1h | M1i |
|---|---|---|---|
| 1 | 0.00 | 0.00 | 0.00 |
| 2 | −1.28 | −1.42 | −1.29 |
| 5 | −2.99 | −2.64 | −2.44 |
| 7 | −3.48 | −2.93 | −2.74 |
| 14 | −4.19 | −3.25 | −2.85 |
| 21 | −4.56 | −3.43 | −3.06 |
| 28 | −4.75 | −3.59 | −3.38 |
| Shrinkage reduction after 28 d | | 24% | 29% |

As is evident from Tables 5 and 6, even lower shrinkage values can be achieved by an increase in the amount of additive (cf. M1h and M1i).

### Example 4

TABLE 7
Test formulations, data in parts by mass

| Raw materials | M2 | M2a | M3 | M3a |
|---|---|---|---|---|
| Ground granulated blast furnace slag | | | | |
| Coal fly ash | | | 50 | 50 |
| Metakaolin | 200 | 200 | 130 | 130 |
| Portland cement 52.5R | | | 20 | 20 |
| Quartz sand | 800 | 800 | 800 | 800 |
| Polydimethylsiloxane having phenyl | | 10 | | 10 |
| groups (AR 1000 ®, from Wacker) | | | | |
| Potassium waterglass | 350 | 350 | 280 | 280 |
| (modulus 1, solids content 40%) | | | | |

TABLE 8
Results of the shrinkage measurement in mm · m⁻¹

| Age/days | M2 | M2a | M3 | M3a |
|---|---|---|---|---|
| 1 | 0.00 | 0.00 | 0.00 | 0.00 |
| 2 | −3.86 | −3.41 | −3.69 | −2.77 |
| 5 | −4.80 | −4.15 | −4.59 | −3.58 |
| 7 | −4.83 | −4.26 | −4.67 | −3.70 |
| 14 | −4.79 | −4.41 | −4.70 | −3.89 |
| 21 | −4.84 | −4.43 | −4.74 | −3.95 |
| 28 | −4.85 | −4.50 | −4.74 | −4.05 |
| Shrinkage reduction after 28 d | | 7% | | 15% |

Both in the case of metakaolin as the sole binder (M2 and M2a) and in the case of the binder composition comprising coal fly ash, metakaolin and Portland cement, a reduction of the shrinkage, as the result of addition of a polydimethylsiloxane having proportions of phenyl groups, is evident.

### Example 5

TABLE 9
Test formulations, data in parts by mass

| Raw materials | M4 | M4a | M5 | M5a |
|---|---|---|---|---|
| Ground granulated blast furnace slag | 200 | 200 | 150 | 150 |
| Microsilica | 50 | 50 | | |
| Metakaolin | | | 50 | 50 |
| Coal fly ash | | | 50 | 50 |
| Quartz sand | 750 | 750 | 750 | 750 |
| Polydimethylsiloxane (AK 1000 ®, from | | 20 | | |
| Wacker) | | | | |
| Polydimethylsiloxane having phenyl | | | | 10 |
| groups (AR 1000 ®, from Wacker) | | | | |
| Potassium waterglass | | | 240 | 240 |
| (modulus 1, solids content 40%) | | | | |
| Sodium hydroxide solution (10% strength) | 180 | 180 | | |

TABLE 10
Results of the shrinkage measurement in mm · m⁻¹

| Age/days | M4 | M4a | M5 | M5a |
|---|---|---|---|---|
| 1 | 0.00 | 0.00 | 0.00 | 0.00 |
| 2 | −0.09 | −0.02 | −3.88 | −2.08 |
| 5 | −0.38 | −0.23 | −5.77 | −3.36 |
| 7 | −0.58 | −0.38 | −6.21 | −3.70 |
| 14 | −0.94 | −0.46 | −6.95 | −4.22 |
| 21 | −1.13 | −0.56 | −7.28 | −4.46 |
| 28 | −1.32 | −0.68 | −7.44 | −4.66 |
| Shrinkage reduction after 28 d | | 48% | | 37% |

The positive influence of the polysiloxanes regarding the shrinkage also occurs in the case of different activator components (for example sodium hydroxide solution in M4 and M4a). Further binder variations, such as, for example, ground granulated blast furnace slag, metakaolin and coal fly ash, as mentioned in mixture M5, can also be prepared in shrinkage-reduced form by the use of polysiloxanes.

The tests show the surprisingly good efficiency of the shrinkage reducers according to the invention over a wide range of different binder compositions.

2. Hydrophobization/Water Absorption

Sample Preparation:

The production of the test specimens and the determination of the water absorption were effected on the basis of DIN EN 12808-5. As for the determination of the shrinkage values, first all pulverulent constituents according to Table 11 were premixed. Thus, in the first step, for example, first the binders ground granulated blast furnace slag, microsilica and/or metakaolin are mixed together with the quartz sand filler.

For the preparation of the mixtures (M6a, M6b and M7a) according to the invention, this mixture is sprayed in the second step with the respective siloxane and mixed again.

The preparation of a homogeneous mixture by addition of the activator with stirring is then effected according to DIN EN 196.

Production and storage of the test specimens, or tests:

Test specimen prisms having the dimensions 4×4×16 cm³ are produced from the stirred binders according to DIN EN 196 and stored according to said standard at a temperature of 23° C. and a relative humdity of 50%. After 21 days, the lateral surfaces are sealed with a silicone sealant. 28 days after the production, the individual test specimens should be weighed and then placed upright in a dish containing water to a depth of about 5 mm. The measurement of the water absorption is effected after 30 and 240 minutes by removing the prisms from the water and drying them with a moistened cloth and weighing them.

All mixtures mentioned are two-component mixtures since the activators (potassium waterglass or sodium hydroxide solution) are added separately. The mixtures M6 and M7 are mentioned as comparative systems and, in comparison with M6a, M6b and M7a, contain no organic additive.

### Example 6

TABLE 11
Test formulations, data in parts by mass

| Raw materials | M6 | M6a | M6b | M7 | M7a |
|---|---|---|---|---|---|
| Ground granulated blast furnace slag | 150 | 150 | 150 | 200 | 200 |
| Microsilica | 50 | 50 | 50 | | |
| Metakaolin | 50 | 50 | 50 | | |
| Coal fly ash | | | | 50 | 50 |
| Quartz sand | 750 | 750 | 750 | 750 | 750 |
| Polydimethylsiloxane (AK 1000 ®, | | | | | 10 |
| from Wacker) | | | | | |
| Polydimethylsiloxane having phenyl | | 10 | 20 | | |
| groups (AR 1000 ®, from Wacker) | | | | | |
| Potassium waterglass | 240 | 240 | 240 | 250 | 250 |
| (modulus 1, solids content 40%) | | | | | |

TABLE 12
Results for the determination of the water absorption in g

| | M6 | M6a | M6b | M7 | M7a |
|---|---|---|---|---|---|
| after 30 min | 1.50 | 0.06 | 0.03 | 2.21 | 0.08 |
| after 240 min | 4.30 | 0.30 | 0.24 | 5.61 | 0.20 |

On comparison of the measured values after 30 and 240 minutes, a substantial reduction in the water absorption is evident, both on addition of polydimethylsiloxanes (M6a and M6b) and in the case of a polydimethylsiloxane having phenyl groups (M7a). The large reduction in the water absorption as a result of the addition of the additives according to the invention was surprising for the specific binders.

1. Mixture containing alkali-activatable aluminosilicate binders, wherein the mixture contains organosiloxane compounds.

2. Mixture according to claim 1, wherein the mixture contains ground granulated blast furnace slag, fly ash and/or microsilica as binders.

3. Mixture according to claim 1, wherein the mixture contains metakaolin as a further binder.

4. Mixture according to claim 1, wherein the binders have a specific surface area (Blaine value) of greater than 2000 cm²/g.

5. Mixture according to claim 1, wherein the mixture contains at least one organosiloxane compound of the structural formula (I) 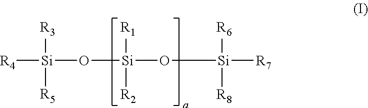
in which a is an integer from 1 to 2000,
R₁ and R₂ are identical or different and, independently of one another, are a branched or straight-chain alkyl having up to 20 carbon atoms,
phenyl, vinyl,
—OH,
—H,
—CH₂—CHCH₃-phenyl,
—CH₂—CH₂—(CF₂)ₓ—CF₃, in which x is an integer from 0 to 20,
and/or —CH₂—CH₂—CH₂—(OA)ₙ-OR₉, in which A are identical or different and, independently of one another, are a branched or straight-chain alkylene having two to 10 carbon atoms, n are identical or different and, independently of one another, are an integer between 1 and 300 and R₉ are identical or different and, independently of one another, are a group selected from methyl, ethyl, phenyl and/or H,
R₃, R₄, R₅, R₆, R₇, R₈ are identical or different and, independently of one another, are a branched or straight-chain alkyl having up to 20 carbon atoms, phenyl,
vinyl,
halogen,
—OR₁₀, where R₁₀ is selected from methyl, ethyl, phenyl and/or H,
—H,
and/or —CH₂—CH₂—CH₂—(OA)ₙ-OR₉, in which A are identical or different, and, independently of one another, are a branched or straight-chain alkylene having two to 10 carbon atoms, n are identical or different and, independently of one another, are an integer between 1 and 300 and R₉ are identical or different and, independently of one another, are a group selected from methyl, ethyl, phenyl and/or H.

6. Mixture according to claim 5, wherein in the structural formula (I),
R₁ and R₂ are identical or different and, independently of one another, are
methyl,
phenyl,
H,
and/or —CH₂—CH₂—CH₂—(OA)ₙ-OR₉, in which A are identical or different and, independently of one another, are a branched or straight-chain alkylene having two or three carbon atoms, n are identical or different and, independently of one another, are an integer between 1 and 300; and R₉ are identical or different and, independently of one another, are a group selected from methyl and/or H,
R₃, R₄, R₅, R₆, R₇, R₈ are identical or different and, independently of one another, are alkyl having up to 20 carbon atoms,
—OR₁₀, where R₁₀ is selected from methyl, ethyl, phenyl and/or H,
—H,
and/or —CH₂—CH₂—CH₂—(OA)ₙ-OR₉, in which A are identical or different and, independently of one another, are a branched or straight-chain alkylene having two or three carbon atoms, n are identical or different and, independently of one another, are an integer between 1 and 300 and R₉ are identical or different and, independently of one another, are a group selected from methyl and/or H.

7. Mixture according to any of claim 1, wherein an organosiloxane compound of the structural formula (II) is present 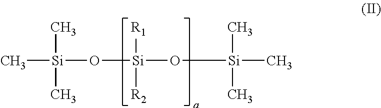
in which R₁ and R₂ are identical or different and, independently of one another, are methyl,
and/or —CH₂—CH₂—CH₂—(OA)ₙ—OR₉, in which A are identical or different and, independently of one another, are a branched or straight-chain alkylene having two or three carbon atoms, n are identical or different and, independently of one another, are an integer between 1 and 300 and R₉ are identical or different and, independently of one another, are a group selected from methyl and/or H.

8. Mixture according to claim 1, wherein the mixture contains at least one cyclic organosiloxane compound of the structural formula (III) 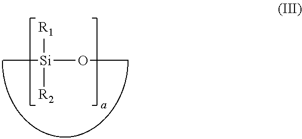
in which a is an integer from 3 to 6,
R₁ and R₂ are identical or different and, independently of one another, are
methyl,
phenyl,
vinyl,
—H,
and/or —CH₂—CH₂—CF₃.

9. Mixture according to claim 1, wherein the mixture contains 0 to 50% by weight of cement.

10. Mixture according to claim 1, wherein the mixture contains no cement.

11. Mixture according to claim 1, wherein the mixture contains an activator.

12. Mixture according to claim 1, wherein the mixture contains an alkali metal compound as the activator.

13. Mixture according to claim 11, wherein the mixture contains alkali metal and/or alkaline earth metal hydroxides as the activator.

14. Mixture according to claim 11 wherein the mixture contains alkaline waterglass as the activator.

15. Mixture according to claim 1, wherein the following components are present in the mixture:
between 0.01 and 15% by weight of organosiloxane compounds,
between 1 and 90% by weight of alkali-activatable aluminosilicate binder,
the stated weights being based in each case on the total weight of the mixture.

16. (canceled)

17. (canceled)

18. Joint mortars, levelling compounds or coatings containing mixtures according to claim 1.
